(19) United States
(12) Patent Application Publication
(10) Pub. No.: US 2026/0064028 A1
(43) Pub. Date: Mar. 5, 2026

(54) EXPOSURE DEVICE AND IMAGE FORMING APPARATUS

(71) Applicant: SHARP KABUSHIKI KAISHA, Osaka (JP)

(72) Inventors: HIROSHI YAMAMOTO, Osaka (JP); Akito TERAMOTO, Osaka (JP); Songhuan PIAO, Osaka (JP); Katsuaki YAMADA, Osaka (JP); Kenzo OHKUBO, Osaka (JP)

(21) Appl. No.: 19/311,233

(22) Filed: Aug. 27, 2025

(30) Foreign Application Priority Data
Sep. 4, 2024 (JP) 2024-151920

(51) Int. Cl. G03G 15/04; B41J 2/45; G02B 7/02; G02B 19/00

(52) U.S. Cl. CPC G03G 15/04054; B41J 2/451; G02B 7/028; G02B 19/0009; G02B 19/0047

(57) ABSTRACT

An image forming apparatus includes: a panel member opposing a photoreceptor drum and having plural light-emitting elements; a lens focusing light emitted from the light-emitting elements onto the photoreceptor drum; and a holding member holding the lens. The holding member and the lens adhere to each other in a first adhesive region located at a center in a longitudinal direction (width direction) and a second adhesive region located at an end in the longitudinal direction. A shrinkage rate differs between the first adhesive region and the second adhesive region.

### CROSS-REFERENCE TO RELATED APPLICATIONS

The present application claims priority from Japanese Application JP 2024-151920, the content to which is hereby incorporated by reference into this application.

### BACKGROUND OF THE INVENTION

### 1. Field of the Invention

The present disclosure relates to an exposure device having a lens that focuses light emitted from a light-emitting element on a photoreceptor, and to an image forming apparatus.

### 2. Description of the Related Art

Conventionally, an electrophotographic image forming apparatus has been widely used in which an electrostatic latent image is formed on a photoreceptor by using a laser beam or the like, and an image is formed on paper through processes of developing, transferring, and fixing this electrostatic latent image. In recent years, a linear light source (a light-emitting diode (LED) array), in which point light sources such as light-emitting elements are linearly arranged, is sometimes used as a light source that exposes the photoreceptor, and a lens is provided to form an image of the light emitted from the LED array on a surface of the photoreceptor. The lens is held via a holder. However, when the holder is deformed by being twisted or bent, a focal position is possibly shifted. Thus, a method for attaching the lens in a manner to prevent shifting of the focal position thereof is adopted.

### SUMMARY OF THE INVENTION

A conventional LED head includes: a substrate on which the LED array is mounted; a lens array provided on a light-emitting surface side of the LED array; a base having a flat surface on which the substrate is placed and side surfaces on both sides, each of which extends downward from a respective side of the flat surface perpendicularly to the flat surface; and plural support members that are respectively arranged at plural positions in a longitudinal direction on one side of the substrate and support the lens array, and to each of which a side surface on one side of the lens array is bonded by an adhesive.

In the conventional LED head, the lens array is held by the holder that extends along the longitudinal direction. When the holder is warped, the lens is possibly distorted.

The present disclosure has been made to solve the above problem, and an object thereof is to provide an exposure device and an image forming apparatus capable of reducing warpage of a lens holding member and thereby preventing focus failure caused by the warpage.

An exposure device according to an aspect of the present disclosure is an exposure device including: a panel member that opposes a photoreceptor and has plural light-emitting elements; a lens that focuses light emitted from the light-emitting elements onto the photoreceptor; and a holding member that holds the lens. The holding member and the lens adhere to each other in a first adhesive region located at a center in a longitudinal direction and a second adhesive region located at an end in the longitudinal direction. A shrinkage rate differs between the first adhesive region and the second adhesive region.

In the exposure device according to the aspect of the present disclosure, adhesives having different shrinkage rates may be used for the first adhesive region and the second adhesive region.

In the exposure device according to the aspect of the present disclosure, the shrinkage rates of the first adhesive region and the second adhesive region may be set on the basis of a warpage amount of the holding member in the longitudinal direction.

In the exposure device according to the aspect of the present disclosure, the holding member and the lens may adhere to each other in a third adhesive region that is provided between the first adhesive region and the second adhesive region, and the shrinkage rate may be changed stepwise in an order of the first adhesive region, the third adhesive region, and the second adhesive region.

In the exposure device according to the aspect of the present disclosure, an adhesive area may differ between the first adhesive region and the second adhesive region.

In the exposure device according to the aspect of the present disclosure, an application amount of an adhesive may differ between the first adhesive region and the second adhesive region.

An image forming apparatus according to another aspect of the present disclosure includes the exposure device according to the present disclosure.

According to the aspects of the present disclosure, warpage of the holding member can be reduced when the different shrinkage rates caused by adhesion are set to the holding member whose warpage amount differs between a central portion and an end portion. As a result, it is possible to prevent focus failure caused by the warpage of the holding member.

### BRIEF DESCRIPTION OF THE DRAWINGS

FIG. 1 is a schematic cross-sectional view illustrating an image forming apparatus according to an embodiment of the present disclosure.

FIG. 2 is a perspective view illustrating a print head of an exposure device.

FIG. 3 is a top view of the print head illustrated in FIG. 2.

FIG. 4 is a schematic cross-sectional view of the print head illustrated in FIG. 2.

FIG. 5 is an explanatory view illustrating a positional relationship of a holding member warped upward to a reference line.

FIG. 6 is an explanatory view illustrating a positional relationship of the holding member warped downward to the reference line.

### DETAILED DESCRIPTION OF THE INVENTION

A description will hereinafter be made on an image forming apparatus according to an embodiment of the present disclosure with reference to the drawings.

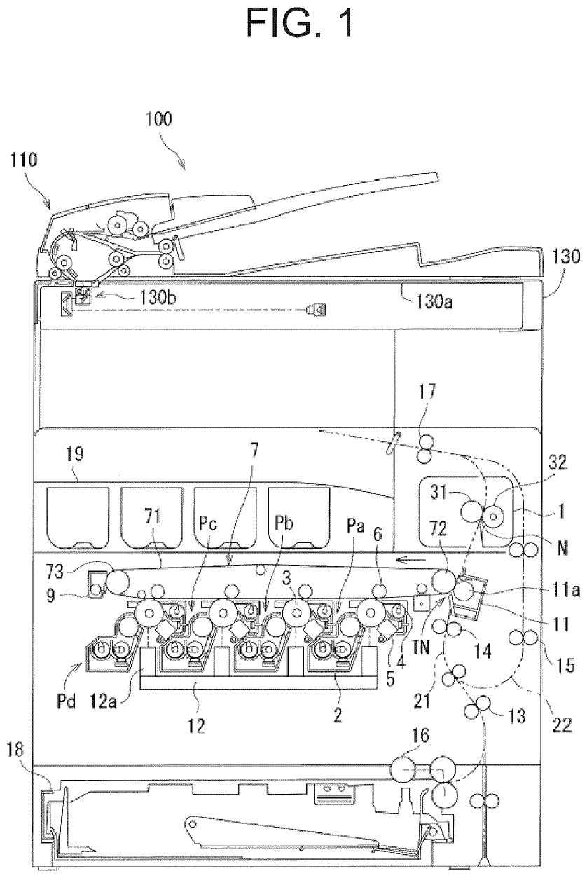

FIG. 1 is a schematic cross-sectional view illustrating the image forming apparatus according to the embodiment of the present disclosure.

An image forming apparatus 100 is a multifunction peripheral having a copier function, a scanner function, a facsimile machine function, and a printer function. The image forming apparatus 100 transmits an image of a document read by an image reader 130 to an external destination, or forms the image of the document read by the image reader 130 or an image received from an external source on a recording medium such as paper in color or monochrome.

A document conveyor 110 is provided above the image reader 130, and is supported in a freely openable/closable manner. The document conveyor 110 conveys one or more document sheets one at a time in sequence. The image reader 130 scans the document placed on a document table 130a or the document conveyed by the document conveyor 110 with an optical scanning system 130b, and thereby generates image data.

The image forming apparatus 100 includes a fixing device 1, developing devices 2, photoreceptor drums 3 (an example of photoreceptors), drum cleaners 4, chargers 5, an intermediate transfer belt device 7, a secondary transfer device 11, an exposure device 12, a paper feeder 18, and the like.

The image forming apparatus 100 handles the image data for a color image to be formed by using colors including black (K), cyan (C), magenta (M), and yellow (Y) or for a monochrome image to be formed by using a single color (for example, black). In order to form four different toner images, the image forming apparatus 100 includes four each of the developing devices 2, the photoreceptor drums 3, the drum cleaners 4, and the chargers 5, which respectively correspond to the four colors including black, cyan, magenta, and yellow, and constitute four image stations Pa, Pb, Pc, Pd.

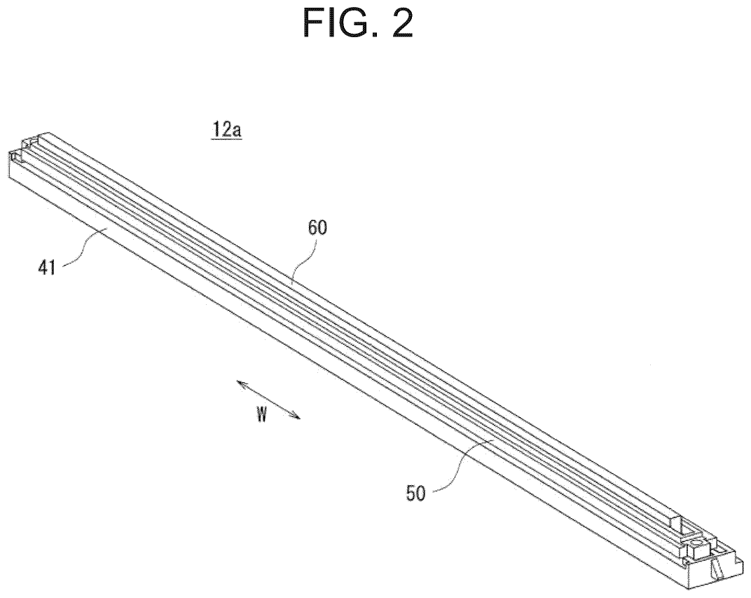

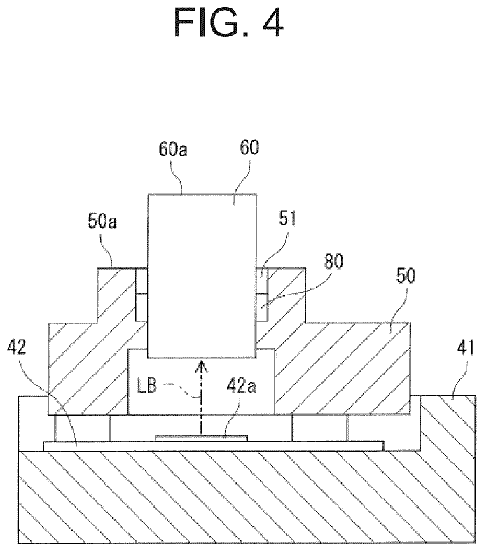

Each of the chargers 5 uniformly charges a surface of the respective photoreceptor drum 3 to a predetermined potential. The exposure device 12 has panel members 42 that respectively oppose the surfaces of the photoreceptor drums 3, and exposes the surfaces of the photoreceptor drums 3 to form electrostatic latent images. Each of the developing devices 2 develops the electrostatic latent image on the surface of the respective photoreceptor drum 3 to form a toner image on the surface of the respective photoreceptor drum 3. Each of the drum cleaners 4 removes and collects residual toner on the surface of the respective photoreceptor drum 3. The toner images in the respective colors are formed on the surfaces of the photoreceptor drums 3 through a sequence of the above-described operations. A detailed description on the panel member 42 will be made below with reference to FIG. 2 or FIG. 4.

The intermediate transfer belt device 7 includes intermediate transfer rollers 6, an endless intermediate transfer belt 71, an intermediate transfer driving roller 72, an intermediate transfer driven roller 73, and a cleaner 9. The four intermediate transfer rollers 6 are provided inside the intermediate transfer belt 71 in a manner to form the four different toner images corresponding to the respective colors. The intermediate transfer rollers 6 transfer the toner images in the respective colors, which are formed on the surfaces of the photoreceptor drums 3, to the intermediate transfer belt 71 in rotational movement.

The intermediate transfer belt 71 is stretched around the intermediate transfer driving roller 72 and the intermediate transfer driven roller 73. In the image forming apparatus 100, the toner images in the respective colors, which are formed on the surfaces of the photoreceptor drums 3, are sequentially transferred and superimposed on a surface of the intermediate transfer belt 71 to form a color toner image thereon. The cleaner 9 removes and collects waste toner that remains on the surface of the intermediate transfer belt 71 without being transferred onto the paper.

The secondary transfer device 11 nips and conveys the paper, which has been conveyed through a paper conveyance path 21, to a transfer nip TN between a secondary transfer roller 11a and the intermediate transfer belt 71. When passing through the transfer nip TN, the paper receives the toner image transferred from the surface of the intermediate transfer belt 71, and is then conveyed to the fixing device 1.

The fixing device 1 includes a fixing belt 31 and a pressure roller 32 that rotate about respective axes. The fixing device 1 nips the paper having the transferred toner image thereon with a nipper N between the fixing belt 31 and the pressure roller 32, and applies heat and a pressure to fix the toner image onto the paper. Although not illustrated in FIG. 1, the fixing device 1 may have components other than the fixing belt 31 and the pressure roller 32.

The paper feeder 18 includes a paper feed cassette that loads the recording media (the paper) used for the image formation, and is provided below the exposure device 12. The paper is pulled out from the paper feeder 18 by a pickup roller 16 and conveyed to the paper conveyance path 21. The paper conveyed to the paper conveyance path 21 goes through the secondary transfer device 11 and the fixing device 1, and is discharged onto a paper discharge tray 19 by discharge rollers 17.

Conveyance rollers 13, paper stop rollers 14, and the discharge rollers 17 are arranged along the paper conveyance path 21. The conveyance rollers 13 facilitate conveyance of the paper. The paper stop rollers 14 convey the paper at the same speed as a process speed at which the image is formed on the paper. These paper stop rollers 14 are provided between the paper feeder 18 and the secondary transfer device 11, and adjust paper conveyance timing such that the toner image is transferred onto the paper at the secondary transfer device 11. For example, the paper stop rollers 14 wait (are stopped temporarily) while holding the paper conveyed from the paper feeder 18 therebetween, and then start conveying the paper at a constant speed in synchronization with the secondary transfer device 11.

In a case where the image is formed not only on a front surface of the paper but also on a back surface of the paper, a paper conveyance direction is changed at the discharge rollers 17, and the paper is then conveyed to a reverse conveyance path 22. In the reverse conveyance path 22, the paper is guided to the paper stop rollers 14 by reverse conveyance rollers 15 while the front and back surfaces of the paper are reversed. The image forming apparatus 100 forms the image on the back surface of the paper guided to the paper stop rollers 14 in the same manner as on the front surface, and then discharges the paper to the paper discharge tray 19.

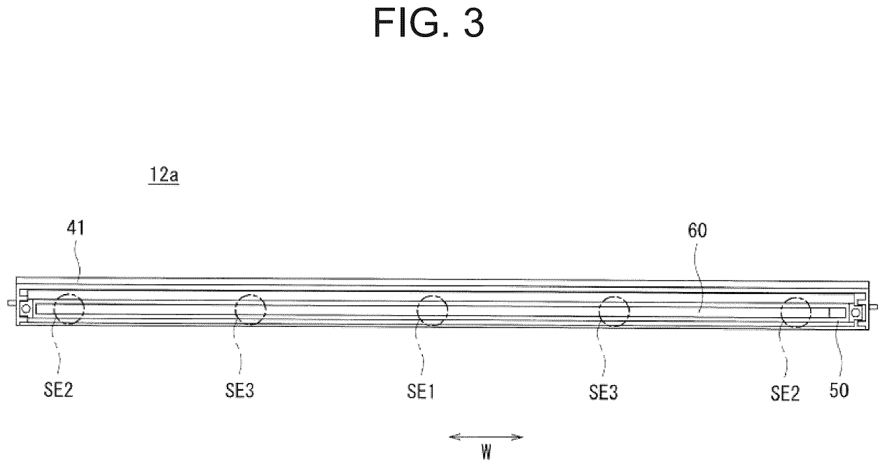

FIG. 2 is a perspective view illustrating a print head of the exposure device, and FIG. 3 is a top view of the print head illustrated in FIG. 2. In FIG. 2, a part of a print head 12a is extracted, and other members not illustrated in FIG. 2 may appropriately be provided.

In the exposure device 12, the four print heads 12a, each of which has the panel member 42, are provided in a manner to oppose the four photoreceptor drums 3, respectively. The exposure device 12 may be provided independently for each of the photoreceptor drums 3, and only needs to be provided with the panel members 42 in a manner to correspond to the four photoreceptor drums 3, respectively. Since the four print heads 12a have substantially the same configuration, one of the print heads 12a is extracted and illustrated schematically in FIG. 2.

In the image forming apparatus 100, an axial direction that is along a rotation axis of the photoreceptor drum 3 is parallel to a width direction of the paper to be formed with the image. The photoreceptor drum 3 rotates about the rotation axis. The print head 12a is a rectangular flat plate, a longitudinal direction (a width direction W) thereof corresponds to the axial direction, and a short direction thereof corresponds to a rotational direction of the photoreceptor drum 3.

The print head 12a includes a base member 41, a holding member 50, and a lens 60 (a lens array). As illustrated in FIG. 4 described below, the panel member 42 is attached to an upper surface of the base member 41.

The holding member 50 is formed of a resin or the like, for example, is a frame-shaped member that surrounds side surfaces of the lens 60, and is provided with an opening, which penetrates the holding member 50 in a height direction, at a center. The holding member 50 is attached to the upper surface of the base member 41 in a manner to cover the panel member 42 from above. The lens 60 is attached to the holding member 50 in a manner to be inserted in the opening provided in the holding member 50.

The holding member 50 and the lens 60 adhere to each other at plural positions that are separated from each other in the width direction W. As adhesive regions between the holding member 50 and the lens 60, a first adhesive region SE1 located at a center, a second adhesive region SE2 located at both ends, and a third adhesive region SE3 located between the first adhesive region SE1 and each of the second adhesive regions SE2 are set in the width direction W.

FIG. 4 is a schematic cross-sectional view of the print head illustrated in FIG. 2. In FIG. 4, in order to facilitate understanding of the structure, only the base member 41 and the holding member 50 are hatched, and the other members are not hatched.

The panel member 42 includes plural light-emitting elements 42a. Each of the light-emitting elements 42a is an organic electroluminescent (EL) diode (OLED) or an LED, for example. In FIG. 4, in order to facilitate understanding of the light-emitting element 42a, the light-emitting element 42a is provided to protrude from an upper surface of the panel member 42. However, in reality, the light-emitting element 42a is formed inside the panel member 42 so as not to protrude from the upper surface thereof.

Both end portions of the holding member 50 in the width direction W are fixed to the base member 41. In a portion facing the panel member 42, the holding member 50 is held in a manner to be separated from the base member 41. A structure of providing a clearance between the holding member 50 and the base member 41 may be designed appropriately. For example, a step may be provided on the upper surface of the base member 41 such that both end portions thereof protrude and support the holding member 50, or a spacer may be interposed and fixed between the holding member 50 and the base member 41.

In the holding member 50, a portion corresponding to the adhesive region is formed with an application region 51 by cutting an edge of the opening, to which the lens 60 is attached. The application region 51 is a groove that extends downward from the upper surface (an upper holding surface 50a) of the holding member 50, and is a portion that receives an adhesive 80 dropped from above.

In the present embodiment, an ultraviolet (UV) adhesive (UV curing adhesive) is used as the adhesive 80 that attaches the lens 60 and the holding member 50. When the lens 60 and the holding member 50 adhere to each other, the adhesive 80 is dropped into the application region 51, and the adhesive 80 is then irradiated with the UV (UV rays) and cured. As the adhesive 80, for example, plural types of adhesives having different shrinkage rates, such as an epoxy-based adhesive, an acrylic-based adhesive, and a modified acrylate-based adhesive, may be used appropriately.

As illustrated in FIG. 4, light LB emitted from the light-emitting element 42a is focused on a surface of the photoreceptor drum 3 through an upper surface (an upper lens surface 60a) of the lens 60. Here, a clearance between the light-emitting element 42a and the lens 60 is ideally 0.05 mm or less. When this clearance significantly deviates from a set value, focus failure possibly occurs. By the way, the holding member 50 is formed of the resin, and is possibly warped due to molding. In an assembly process, the lens 60 and the holding member 50 adhere to each other in a state where warpage of the holding member 50 is corrected. However, when the correction is canceled, the lens 60 is possibly distorted by a force that attempts to recover the warpage.

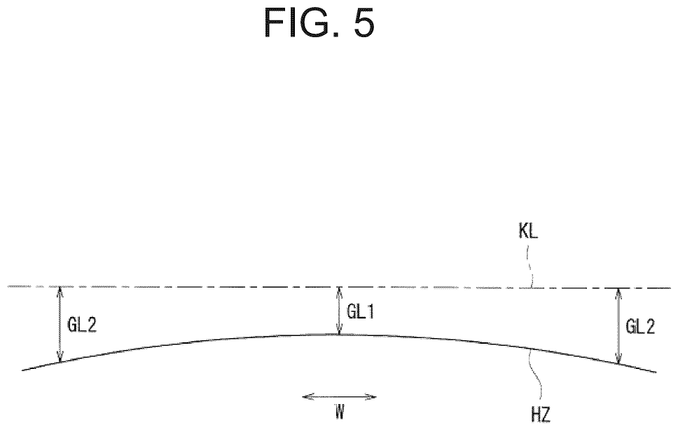

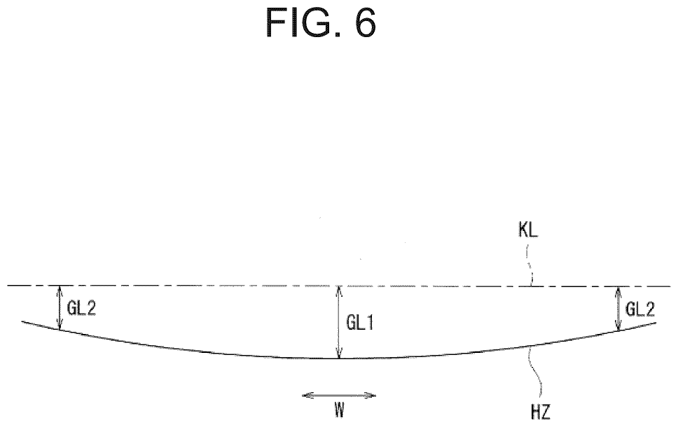

To handle such a problem, in the present disclosure, the warpage of the holding member 50 is reduced by setting the different shrinkage rates to the adhesive regions. Next, a description will be made on the warpage of the holding member 50 in each of the adhesive regions with reference to FIGS. 5 and 6.

FIG. 5 is an explanatory view illustrating a positional relationship of the holding member warped upward to a reference line, and FIG. 6 is an explanatory view illustrating a positional relationship of the holding member warped downward to the reference line.

FIGS. 5 and 6 illustrate transition of the positional relationship between the upper surface (the upper holding surface 50a) of the holding member 50 and a reference line KL. An upper surface curve HZ indicates a height of the upper holding surface 50a measured in advance, shows transition along the width direction W, and corresponds to the warpage of the holding member 50 in the width direction W. The reference line KL is a horizontal straight line that assumes the upper lens surface 60a. In FIGS. 5 and 6, a distance between the upper surface curve HZ and the reference line KL in the height direction is set as a warpage amount of the holding member 50. A first warpage amount GL1 indicates a warpage amount in a portion corresponding to the first adhesive region SE1, and a second warpage amount GL2 indicates a warpage amount in a portion corresponding to the second adhesive region SE2.

The upper surface curve HZ illustrated in FIG. 5 corresponds to the holding member 50 that is warped upward. In the holding member 50, the portion corresponding to the first adhesive region SE1 protrudes upward, and the portion corresponding to the second adhesive region SE2 is lowered. Accordingly, the upper surface curve HZ is a curve whose center protrudes upward to be convex upward, and the first warpage amount GL1 is smaller than the second warpage amount GL2.

When the lens 60 and the holding member 50 adhere to each other, a degree of the warpage correction becomes significant with an increase in the shrinkage rate. In the case of FIG. 5, the shrinkage rate by adhesion in the first adhesive region SE1 is set to be smaller than the shrinkage rate by adhesion in the second adhesive region SE2. More specifically, an adhesive having a low shrinkage rate is used for the first adhesive region SE1 while an adhesive having a high shrinkage rate is used for the second adhesive region SE2.

The upper surface curve HZ illustrated in FIG. 6 corresponds to the holding member 50 that is warped downward. In the holding member 50, the portion corresponding to the first adhesive region SE1 protrudes downward, and the portion corresponding to the second adhesive region SE2 is raised. Accordingly, the upper surface curve HZ is a curve whose center protrudes downward to be convex downward, and the first warpage amount GL1 is larger than the second warpage amount GL2. In the case of FIG. 6, the adhesive having the high shrinkage rate is used for the first adhesive region SE1 while the adhesive having the low shrinkage rate is used for the second adhesive region SE2.

As described above, the warpage of the holding member 50 can be reduced when the different shrinkage rates caused by the adhesion are set to the holding member 50 whose warpage amount differs between a central portion and an end portion. As a result, it is possible to prevent the focus failure caused by the warpage of the holding member 50. In addition, by using the adhesives 80 having the different shrinkage rates, it is possible to easily set the different shrinkage rates. Furthermore, it is possible to set the appropriate shrinkage rates by considering the warpage amount of the holding member 50 measured in advance.

The adhesive 80 has to be applied at least to the first adhesive region SE1 and the second adhesive region SE2. However, when the lens 60 and the holding member 50 adhere to each other further firmly, the adhesive 80 may also be applied to the third adhesive region SE3. At this time, the types of the adhesive 80 may be selected appropriately such that the shrinkage rate is changed stepwise in an order of the first adhesive region SE1, the third adhesive region SE3, and the second adhesive region SE2. That is, the warpage of the holding member 50 can be reduced gradually by changing the shrinkage rate stepwise from the central portion toward the end portion in the width direction W.

In the present embodiment, the description has been made on the configuration using the adhesives 80 having the different shrinkage rates. However, the present disclosure is not limited thereto, and another method may be used to provide the different shrinkage rates. As the other method, an adhesive area may differ between the first adhesive region SE1 and the second adhesive region SE2. As for the adhesive area, for example, a range of providing the application region 51 only needs to be changed. Alternatively, an application amount of the adhesive 80 may differ between the first adhesive region SE1 and the second adhesive region SE2. By setting the different adhesive areas or the different application amounts of the adhesive 80, just as described, the shrinkage rate can easily be changed.

The embodiment disclosed herein is illustrative in all respects and is not intended to be the basis for a limited interpretation. Therefore, the technical scope of the present disclosure should not be interpreted solely by the above embodiment, but should be defined based on the claims. In addition, the present disclosure also includes all modifications within the meaning and scope of the claims.

What is claimed is:

1. An exposure device comprising:
a panel member that opposes a photoreceptor and has plural light-emitting elements;
a lens that focuses light emitted from the light-emitting elements onto the photoreceptor; and
a holding member that holds the lens, wherein
the holding member and the lens adhere to each other in a first adhesive region and a second adhesive region, the first adhesive region being located at a center in a longitudinal direction, and the second adhesive region being located at an end in the longitudinal direction, and
a shrinkage rate differs between the first adhesive region and the second adhesive region.

2. The exposure device according to claim 1, wherein
adhesives having different shrinkage rates are used for the first adhesive region and the second adhesive region.

3. The exposure device according to claim 1, wherein
the shrinkage rates of the first adhesive region and the second adhesive region are set on the basis of a warpage amount of the holding member in the longitudinal direction.

4. The exposure device according to claim 1, wherein
the holding member and the lens adhere to each other in a third adhesive region that is provided between the first adhesive region and the second adhesive region, and
the shrinkage rate is changed stepwise in an order of the first adhesive region, the third adhesive region, and the second adhesive region.

5. The exposure device according to claim 1, wherein
adhesive areas of the first adhesive region and the second adhesive regions are different.

6. The exposure device according to claim 1, wherein
an application amount of an adhesive differs between the first adhesive region and the second adhesive region.

7. An image forming apparatus comprising:
the exposure device according to claim 1.
